(19) United States
(12) Patent Application Publication
(10) Pub. No.: US 2012/0079402 A1
(43) Pub. Date: Mar. 29, 2012

(54) TERMINAL, METHOD, SYSTEM, AND COMPUTER-READABLE STORAGE MEDIUM FOR ADJUSTING ATTRIBUTES OF USER-INPUT AREA BASED ON USER SELECTION

(75) Inventor: Kyung Hoon KIM, Seongnam-si (KR)

(73) Assignee: NHN BUSINESS PLATFORM CORPORATION, Seongnam-si (KR)

(21) Appl. No.: 13/244,207

(22) Filed: Sep. 23, 2011

(30) Foreign Application Priority Data
Sep. 29, 2010 (KR) 10-2010-0094471

(51) Int. Cl. G06F 3/048

(52) U.S. Cl. 715/764

(57) ABSTRACT

The present disclosure relates to a terminal, method, system and computer-readable storage medium for adjusting attributes of a user input area based on past user selections, which facilitate a present user selection by changing or adjusting attributes of a user-input area based on the number of past user selections. The terminal includes a user reaction information acquisition unit which acquires reaction information based on at least one past user selection of an input area provided to a user, a reaction information update unit which updates the reaction information on the provided input area, an input area exposure attributes adjustment unit which adjusts attributes of the input area based on the updated reaction information, and an input area provision unit which allows an input area based on the adjusted attributes to be displayed on a display unit in response to a user's request to provide an input area.

### CROSS-REFERENCE TO RELATED APPLICATION

This application claims priority from and the benefit under 35 U.S.C. §119(a) of Korean Patent Application No. 10-2010-0094471, filed on Sep. 29, 2010, which is incorporated herein by reference for all purposes as if fully set forth herein.

### BACKGROUND

1. Technical Field

The present disclosure relates to a terminal, method, system and computer-readable storage medium for adjusting attributes of a user input area based on user selections. More particularly, the present disclosure relates to a terminal, method, system and computer-readable storage medium for adjusting attributes of a user input area based on user selections, is which facilitate a present user selection by adjusting attributes of a user-input area based on past user selections.

2. Discussion of the Background

With the development of the Internet, computer terminals have been increasingly used to build, view, send or receive data via digital resource transmission systems. In addition, most mobile communication terminals, such as mobile phones, personal digital assistants, and the like, have been developed to provide the same or similar capabilities to those of computer terminals, such as computer workstations or personal computers (PCs). These computer and mobile communication terminals include office applications, Internet browsers, game platforms, and the like.

Terminals, such as computer terminals or mobile communication terminals, provide numerous confirmation windows or selection windows operated by selection of a Graphical User Interface (GUI).

However, a user often does an unintended selection on a confirmation or selection window depending on the size of display screens or input units of the terminals. In particular, since mobile communication terminals generally have a much smaller display area than computer terminals and have limited scope of devices, a user might mistakenly press an unintended button, for example, “No” instead of “Yes” when clicking a mouse or touching on a screen.

When a user is prompted to input through a conventional keyboard, the user is usually capable of inputting what he desires through keyboard input on a confirmation window, since a distance between soft keys, as in Yes (Y)/No (N), is large. On the other hand, when a is user inputs through motions, such as clicking or touching on a screen, the possibility of inputting wrong data mistakenly increases since the distance between soft keys is narrow and the soft keys have the same size.

The present disclosure is directed to a certain type of inputting mechanisms that help to provide an environment allowing individual users or group users to enter easily in response to non-keyboard input, such as mouse click or screen touch.

### SUMMARY

Exemplary embodiments of the present invention provide a terminal, method, system and computer-readable storage medium for adjusting attributes of an input area based on past user selections, which facilitates a present user selection by changing or adjusting attributes of an input area displayed on a UI screen based on the number of past user selections.

Some exemplary embodiments are also directed to providing a terminal, method, system and computer-readable storage medium for adjusting an attribute of an input area based on past user selections, which facilitate determination of user preference by changing or adjusting attributes of user input areas according to accumulated information on the number of past user selections of a user terminal and/or other user terminals connected to a management server through a communication network.

Additional features of the invention will be set forth in the description which follows, and in part will be apparent from the description, or may be learned by practice of the is invention.

In accordance with one aspect of the present disclosure, a terminal providing a user input area includes: a user reaction information acquisition unit to acquire reaction information based on at least one past user selection of an input area provided to a user; a reaction information update unit to update the reaction information on the provided input area; an input area exposure attributes adjustment unit to adjust attributes of the input area based on the updated reaction information; and an input area provision unit to display an input area based on the adjusted attributes on a display unit in response to a user's request to provide an input area.

In accordance with another aspect of the present disclosure, a method of providing a user input area includes: by a terminal, acquiring reaction information based on past user selections of an input area provided to a user; updating the reaction information on the provided input area; adjusting attributes of the input area based on the updated reaction information; and displaying an input area based on the adjusted attributes on a display unit in response to the user's request to provide an input area.

In accordance with a further aspect of the present disclosure, a system to provide an attribute-adjustable input area to a user terminal based on user reaction information includes: an acquisition unit to acquire reaction information based on a number of past user selections of an input area provided to a user terminal; an update unit to update the reaction information on the provided input area; an attribute adjustment unit to adjust at least one attribute of the input area based on the updated reaction information; and an input area provision unit to display an input area based on the at least one adjusted attribute on a display unit in response to a request to provide an input area from the user terminal.

In accordance with yet another aspect of the present disclosure, a system to is provide attribute-adjustable input areas to user terminals based on user reaction information includes: an acquisition unit to acquire reaction information based on a number of user selections of an input area provided to a first user terminal; an update unit to cumulatively update the reaction information on the input area based on the reaction information acquired from the first user terminal; an attribute adjustment unit to adjust at least one attribute of the input area based on the updated reaction information on the input area; and an input area provision unit which provides an input area based on the adjusted attribute to a second user terminal in response to a request to provide an input area from the second user terminal.

In accordance with yet another aspect of the present disclosure, a method for providing an attribute-adjustable input area to a user terminal based on user reaction information includes: by a management server, acquiring reaction information based on a number of user selections of an input area provided to a user terminal; cumulatively updating the reaction information on the provided input area; adjusting attributes of the input area based on the updated reaction information; and providing an input area based on the adjusted attributes to the user terminal in response to a request to provide an input area from the user terminal.

In accordance with yet another aspect of the present disclosure, a method for providing attribute-adjustable input areas to user terminals based on user reaction information includes: acquiring reaction information based on a number of user selections of an input area provided to a first user terminal; cumulatively updating the reaction information on the input area based on the reaction information acquired from the first user terminal; adjusting attributes of the input area based on the updated reaction information on the input area; and providing an input area based on the adjusted attributes to a second user terminal in response to a request to provide an input area from the second user terminal.

Computer readable storage media for storing a computer program for executing the above and other methods and systems are further provided.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of a terminal to adjust attributes of an input area based on user selections according to an exemplary embodiment of the present disclosure.

FIG. 2 is a block diagram of a controller of a terminal according to an exemplary embodiment of the present disclosure.

FIG. 3 is a flowchart illustrating a method of adjusting attributes of an input area based on user selections according to an exemplary embodiment of the present disclosure.

FIG. 4 is a diagram of a system to realize adjusting attributes of an input area based on user selections from a user terminal connected to a communication network according to an exemplary embodiment of the present disclosure.

FIG. 5 is a block diagram of a management server according to an exemplary is embodiment of the present disclosure.

FIG. 6 is a flowchart of a method of adjusting attributes of input areas based on user selections from user terminals connected to a communication network according to an exemplary embodiment of the present disclosure.

FIG. 7 is a block diagram of a computer that can be employed to execute a method of adjusting attributes of an input area based on user selections according to an exemplary embodiment of the present disclosure.

FIG. 8, FIG. 9, FIG. 10, and FIG. 11 are exemplary views of terminals, on which attributes of an input area are adjusted according to exemplary embodiments of the present disclosure.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It should be understood that any element, operation or command described herein is not to be construed as being an essential or principle feature of the present disclosure unless otherwise explicitly described. As used herein, the singular forms “a”, “an” and “the” are intended to include the plural forms as well unless otherwise indicated. If only a single item is intended, the term “one” or similar terms will be used herein. Throughout the drawings and the detailed description, is unless otherwise described, the same drawing reference numerals are understood to refer to the same elements, features, and structures. The relative size and depiction of these elements may be exaggerated for clarity, illustration, and convenience.

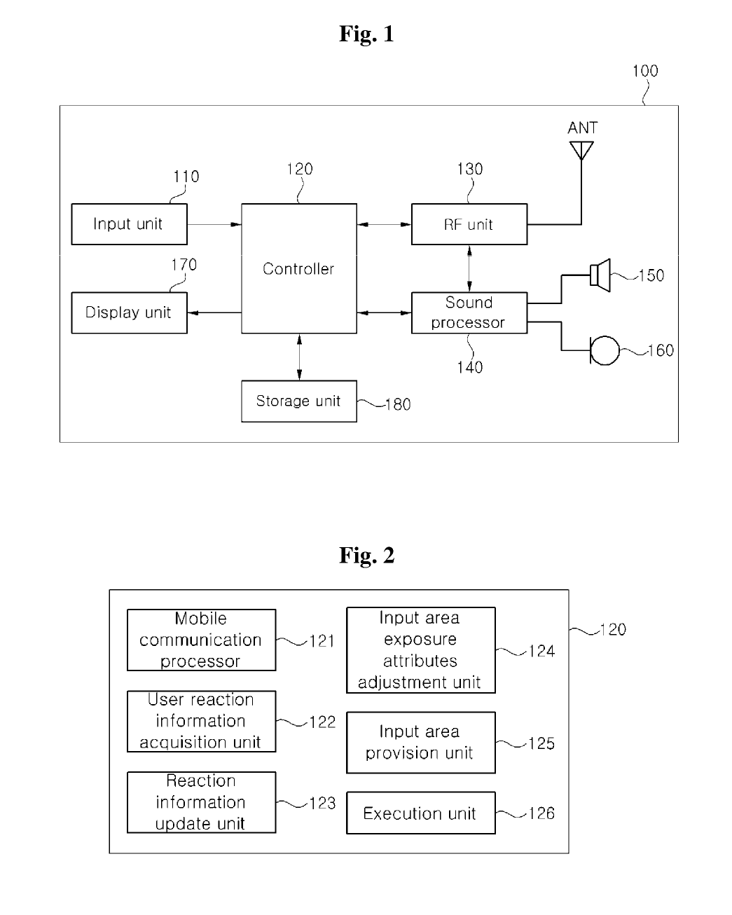

FIG. 1 is a block diagram of a terminal to adjust attributes of an input area based on past user selections according to an exemplary embodiment of the present disclosure, and FIG. 2 is a block diagram of a controller of a terminal according to an exemplary embodiment of the present disclosure.

Although a mobile communication terminal will be described as a terminal to adjust attributes of an input area based on past user selections in this embodiment, the principles of the embodiment may be applied to any information processor including the mobile communication terminal. While the present disclosure exemplarily illustrates, among other things, adjusting attributes of an input area based on the number of past user selections, the principles of the disclosure are also applicable to other characteristics of the user selections such as, when the user selections have been made in a specific time period of a day, where the user selections have been originated from, and so on. Also, while the present disclosure exemplarily illustrates, among other things, adjusting attributes of an input area based on a plurality of past user selections, the principles of the embodiment are applicable to adjusting the attributes of an input area based on a single past user selection.

Referring to FIG. 1, a mobile communication terminal 100 may include an input unit 110, a controller 120, which adjusts attributes of an input area based on past user selections on a User Interface (UI) screen, an RF unit 130 which may process RF signals to communicate with mobile communication terminals, a sound processor 140, a speaker 150, a microphone 160, a display unit 170, a storage unit 180, and the like. Here, the term “input area” may refer to a is region on which a user selects a certain command, such as Yes, No, Cancel, or the like, through mouse click or screen touch, and which may be programmed to carry out a specific operation.

The input unit 110 is comprised of numeral keys, menu keys, and shortcut keys for various functionalities, and outputs key data to the controller 120 in response to user manipulation. Further, the input unit 110 may output a certain command to the controller 120 in response to touch input by a user.

The display unit 170 may be a display device, such as a primary liquid crystal display (LCD) and a secondary LCD, and may be controlled by the controller 120 to display status of the mobile communication terminal or a progress status of program.

In this embodiment, the display unit 170 may include an LCD and a touch panel (not shown). The LCD may display a certain image or text under the control of the controller 120, and the touch panel may detect a touch input by a user and send a detection signal to the controller 120.

In other exemplary embodiments, the input unit 110 and the display unit 170 may be separately realized or may be integrated into a single unit such as a touch panel. Alternatively, the input unit 110, such as a mouse or a keyboard, may be provided together with the touch panel providing functionalities of the input unit 110 and the display unit 170.

The display unit 170 may be controlled by the controller 120 to display a UI screen awaiting user selection. At least two input areas are displayed on the UI screen, and a user may select one of the at least two input areas through, for example, screen touch using a touch pen, mouse click, or the like.

The controller 120 may control overall operations of the mobile communication terminal. Furthermore, the controller 120 may control the display unit 170 to display input areas is on the UI screen awaiting user selection, cumulatively updates reaction information on an input area, which may be selected from among the displayed input areas, and adjusts attributes of an input area to be displayed on the UI screen in response to a subsequent inquiry in consideration of the number of selections of the updated cumulative reaction information.

Further, the controller 120 may provide statistical data of the reaction information on the updated input areas on each UI screen in response to a user request.

The RF unit 130 may be controlled by the controller 120 to convert a signal from the controller 120 into an RF signal. Further, the RF unit 130 may convert an RF signal received through an antenna (ANT) into a desired signal for output.

The sound processor 140 may modulate a sound signal input from the microphone 160 into sound data, and demodulate sound data input from the RF unit 130 and stored in the storage unit 180 into sound signals to be output through the speaker 150.

The storage unit 180 may store a system program and an operation program for the controller 120. Here, the system program or the operation program may generally be stored in a Read Only Memory (ROM) of the storage unit 180 and may be deleted. Further, the controller 123 may include a Random Access Memory (RAM) which may temporarily store data generated during program operation. The storage unit 180 may store the reaction information according to instructions from the controller 120.

Referring to FIG. 2, the controller 120 may include a mobile communication processor 121, which may perform signal processing to provide mobile communication, a user reaction information acquisition unit 122, a reaction information update unit 123, an input area exposure attributes adjustment unit 124, an input area provision unit 125, an execution unit 126, and the like.

The mobile communication processor 121 may be a module to provide mobile communication services using RF data in a mobile communication terminal. The mobile communication processor 121 may be operated based on the mobile communication technologies known in the art, and a detailed description thereof will thus be omitted herein.

The user reaction information acquisition unit 122 may acquire reaction information on an input area selected from among input areas displayed on a UI screen. Here, the term “reaction information” may cover a wide concept that can express which input area is selected by a user from among a plurality of input areas displayed on a specific screen provided by a certain application. The reaction information may include selection information regarding which input area is selected by a user, and input area identification information regarding from which screen a certain input area is selected among screens provided by an application. The user reaction information acquisition unit 122 may acquire reaction information by recognizing a menu selected by a user from among a plurality of menus provided by the mobile communication terminal, and identifying one button selected from among at least two input areas, for example, “Yes” button and “No” button, displayed on a UI screen, which may be provided by execution of the recognized menu and awaiting user selection.

Here, the reaction information may further include information on input areas selected by a user and/or other users from among input areas requiring user reaction.

The reaction information update unit 123 may cumulatively update the reaction information stored in the storage unit 180 through accumulation of the reaction information on the input areas acquired by the user reaction information acquisition unit 122. In one exemplary embodiment, the storage unit 180 may further store the number of selections of a certain user input area. Alternatively, the storage unit 180 may further store reaction history information, is which may include the number of user's selections of input areas having the same reaction information, that is, the same input area identification information, and the same selection information, independently of the reaction information. In this case, the reaction information update unit 123 may also update the number of selections, which are included in the reaction information or in the reaction history information, upon accumulation and update of the reaction information, and the storage unit 180 may store the updated number of selections. The input area exposure attributes adjustment unit 124 may adjust attributes of input areas upon receipt of a subsequent inquiry, based on the number of selections updated by the reaction information update unit 123 and stored in the storage unit 180, such that input areas having larger numbers of selections are distinguished from input areas having smaller numbers of selections. In an example, input areas having larger number of selections may be displayed as a large icon, which may be larger in size than an icon representing an input area having smaller number of selections. Further, input areas having larger number of selections may be distinguished from other input areas by changing a color attribute of the input area, changing fonts, or position of the text in the input area, and/or by changing other attributes of the input area having larger number of selections.

Further, the input area exposure attributes adjustment unit 124 may adjust attributes of one input area having a larger number of selections than the other input area among two input areas in consideration of the numbers of selections stored in the storage unit 180.

Further, the input area exposure attributes adjustment unit 124 may adjust various attributes of two input areas to be proportional to the numbers of selections of the input areas, which may be displayed on a UI screen, with reference to the numbers of selections updated by the reaction information update unit 123.

For example, the input area exposure attributes adjustment unit 124 may adjust area exposure attributes of the input areas among the attributes of the input areas based on the user reaction information. More specifically, when receiving a selected menu from the user reaction information acquisition unit 122, the input area exposure attributes adjustment unit 124 may extract the number of selections of each of two input areas to be displayed on a UI screen of the selected menu from the storage unit 180, compare the numbers of selections of the extracted input areas to determine an input area having a larger number of selections and an input area having a smaller number of selections, and adjust the area exposure attributes of the two input areas such that the area of the input area having a larger number of selections is larger than that of the input area having a smaller number of selections.

For example, when a ratio of the numbers of past selections of two input areas selected by a user is referred to as a:b, in which “a” is the number of selections of Button A and “b” is the number of selections of Button B, the input area exposure attributes adjustment unit 124 may adjust the area exposure attributes of the input areas such that Button A has an area of a/(a+b) and Button B has an area of b/(a+b). The area of each button may increase in a transverse or longitudinal direction. Here, it should be understood that the present invention is not limited to this ratio. For example, the input area exposure attributes adjustment unit 124 may adjust the area exposure attributes of input areas by comparing the numbers of selections of respective two input areas such that the ratio of the areas in the input area having a larger number of selections to the area of an input area having a smaller number of selections becomes 2:1 or 3:1, and so on.

In addition, the input area exposure attributes adjustment unit 124 may adjust the attributes of the input areas by reflecting the reaction history information of a user (in some cases, by reflecting the reaction history information of other users having the same input area is identification information) in order to enhance user convenience. Further, the input area exposure attributes adjustment unit 124 may adjust the area exposure attributes of the input areas to be inversely proportional to the numbers of selections of the respective input areas, which will be displayed on a UI screen, with reference to the updated reaction history information stored in the storage unit 180. For example, when the ratio of the numbers of selections of the respective two input areas is a:b in which “a” is the number of selections of Button A and “b” is the number of selections of Button B, the input area exposure attributes adjustment unit 124 may adjust the area exposure attributes of the input areas such that Button A will have an area of b/(a+b) and Button B will have an area of a/(a+b).

Further, when it is determined that there is a difference between the numbers of selections of the respective two input areas to be displayed on the UI screen, the input area exposure attributes adjustment unit 124 may adjust the area exposure attributes of the two input areas to pre-adjusted attributes based on the numbers of selections of the reaction information stored in the storage unit 180. For example, the input area exposure attributes adjustment unit 124 may adjust the areas in the input area having a larger number of selections and the area of an input area having a smaller number of selections to pre-adjusted sizes, respectively.

In another embodiment, the input area exposure attributes adjustment unit 124 may adjust position exposure attributes among various attributes of input areas based on the reaction information or reaction history information of the user. Specifically, the input area exposure attributes adjustment unit 124 may adjust the position exposure attributes of the input areas to allow an input area having a larger number of selections and an input area having a smaller number of selections to be placed in a UI screen such that the input area having the larger number of selections is positioned at an upper side in a predetermined area on the UI screen and is the input area having a smaller number of selections is positioned at a lower side directly beneath the upper side in the predetermined area. Further, the input area exposure attributes adjustment unit 124 may adjust the position exposure attributes of the input areas such that the input area having the larger number of selections is positioned at a left side and the input area having the smaller number of selections is positioned at a right side or vice versa. In this way, the input area exposure attributes adjustment unit 124 may adjust the position exposure attributes of the input areas such that an input area frequently selected by the user is positioned at a desired location, thereby facilitating the user selection.

Additionally, the input area exposure attributes adjustment unit 124 may adjust at least one of a color exposure attribute relating to a color of an input area and a font exposure attribute relating to a thickness, font, color or size of text in an input area.

The input area provision unit 125 displays a UI screen on the display unit 170, in which the UI screen includes adjusted input areas based on the attributes adjusted by the input area exposure attributes adjustment unit 124. Here, the input areas inside the UI screen on the display unit 170 have different attributes so as to be distinguished by a user.

The execution unit 126 may execute an operation corresponding to an input area selected from among the input areas having different attributes displayed on the UI screen by the input area provision unit 125. When such an operation is executed, the controller 120 may allow the reaction information and/or the reaction history information with respect to a certain input area selected by a user to be accumulated and updated in the storage unit 180.

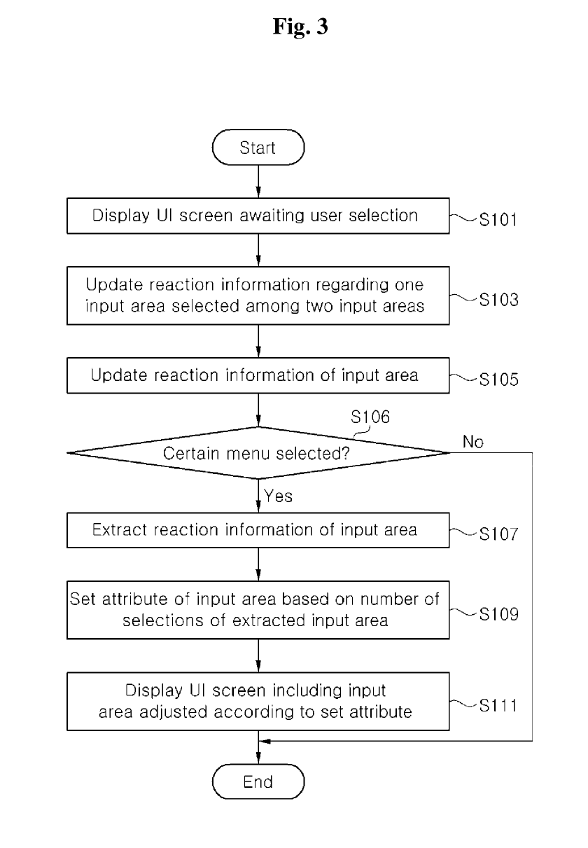

FIG. 3 is a flowchart illustrating a method of adjusting attributes of an input area based on past user selections according to an exemplary embodiment of the present disclosure.

When receiving a certain menu selected by a user, the input area provision unit 125 displays a UI screen awaiting a user selection according to the selected menu in S101.

Next, the user reaction information acquisition unit 122 acquires reaction information on a certain input area selected from among two input areas displayed on the UI screen in S103.

Then, the reaction information update unit 123 updates the storage unit 180 by accumulating the acquired reaction information in S105. Accordingly, the storage unit 180 may store the cumulative reaction information on the certain input area selected from among the two input area by a user and/or other users. Further, the storage unit 180 may accumulate and store reaction information of input areas selected from among the same or similar input areas or reaction information of input areas selected from all input areas awaiting user selection. Here, the numbers of selections of the respective input areas may also be stored therein through an update process.

Then, the input area exposure attributes adjustment unit 124 determines whether a certain menu is selected from the input unit 110 in S106. At this time, the certain menu may be the same as the certain menu in S101.

Upon determining in S106 that no menu is selected from the input unit 110, the controller 120 is maintained in a standby state for a predetermined period of time and then finishes the process if power to a mobile communication terminal is terminated.

Upon determining in S106 that a certain menu is selected from the input unit 110, the input area exposure attributes adjustment unit 124 extracts reaction information on two input areas to be displayed on a UI screen provided according to a selected menu from the storage unit 180 in S107.

Next, the input area exposure attributes adjustment unit 124 adjusts attributes of is the input areas based on the numbers of selections in the extracted reaction information in S109. Specifically, the input area exposure attributes adjustment unit 124 determines an input area having a larger number of selections and an input area having a smaller number of selections based on the numbers of selections in the reaction information stored in the storage unit 180, and adjusts the attributes of the respective input areas such that the input area having a larger number of selections and the input area having a smaller number of selections are displayed to be distinguished from each other. Here, the attributes of each input area may include at least one of an area exposure attribute, a position exposure attribute, a color exposure attribute, and a font exposure attribute.

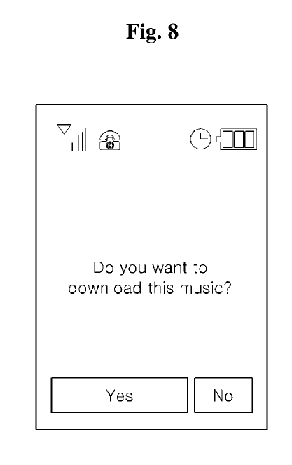

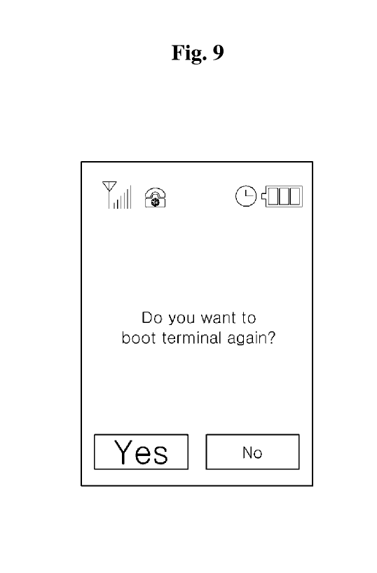

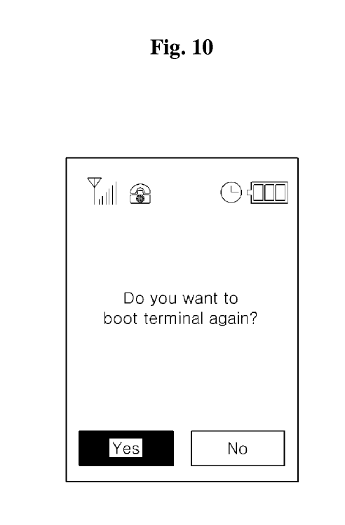

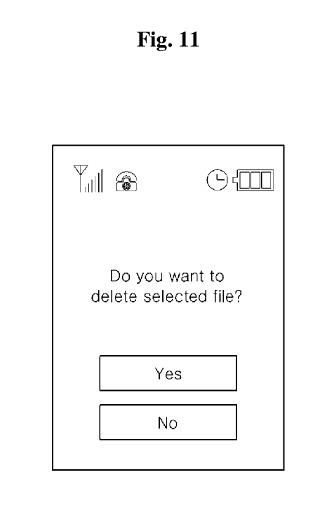

Referring to FIG. 8, the input area exposure attributes adjustment unit 124 may adjust area exposure attributes of the respective input areas to be within a certain ratio or to be proportional to the numbers of selections such that, for example, the input area having a larger number of selections, “Yes”, has a larger area than the input area having a smaller number of selections, “No”. Further, the input area exposure attributes adjustment unit 124 may adjust font exposure attributes of the respective input areas. Further, the input area exposure attributes adjustment unit 124 may adjust color exposure attributes of the input areas such that the input area having a larger number of selections has a certain color and the input area having a smaller number of selections does not have the certain color, as shown in FIG. 9. Further, the input area exposure attributes adjustment unit 124 may adjust position exposure attributes of the respective input areas such that the input area having a larger number of selections is located above the input area having a smaller number of selections, as shown in FIG. 11.

Then, the input area provision unit 125 displays a UI screen including the two input areas adjusted based on the adjusted attributes for the respective input areas on the display is unit 170 in S111.

In this way, the input areas having different attributes are displayed on the UI screen based on past user selections, thereby facilitating a user selection while reducing a possibility of an erroneous user selection.

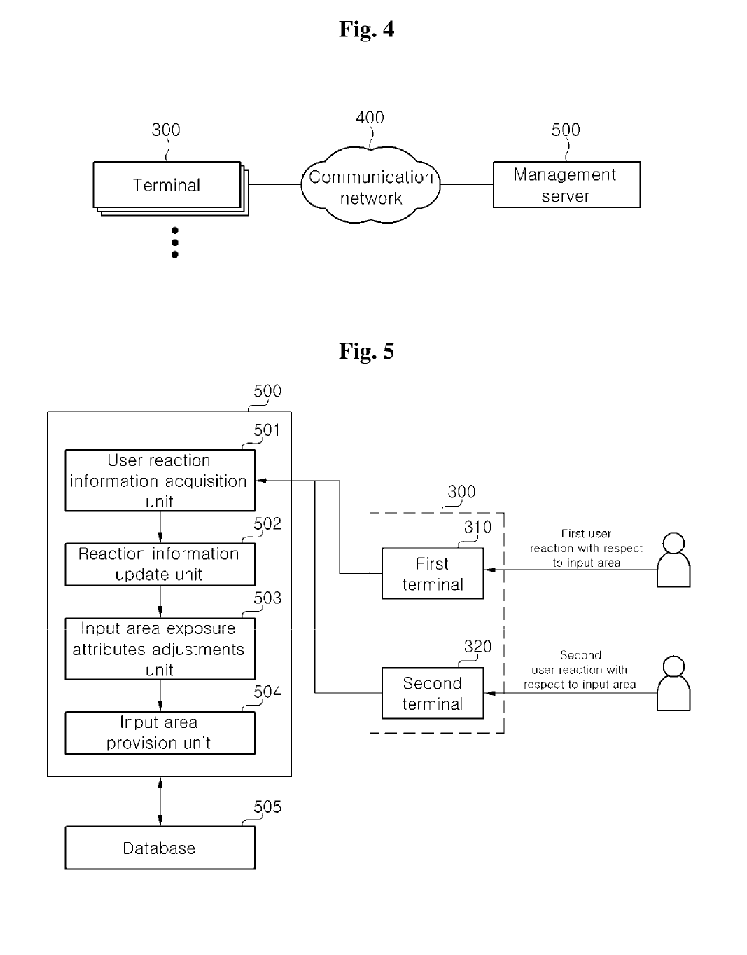

FIG. 4 is a diagram of a system to realize adjusting attributes of an input area based on user selections from a user terminal connected to a communication network according to an exemplary embodiment of the present disclosure.

Referring to FIG. 4, the overall system according to this embodiment includes a plurality of terminals 300, a communication network 400, and a management server 500.

The plurality of terminals 300 are connected to the management server 500 via the communication network 400. The plurality of terminals 300 may receive a web page including information corresponding to a certain inquiry when connecting to the management server 500 and inputting the certain inquiry.

The plurality of terminals 300 may be digital devices that is capable of allowing their respective users to connect to and communicate with the management server 500 through the communication network 400. Any terminal, such as desktop computers, notebook computers, workstations, PDAs, web pads, and mobile phones, may be used as the terminals 300 so long as each of the terminals includes a memory and a microprocessor embedded therein to enable calculation. Further, the terminals 300 may include a web browser program to receive web content.

Each of the terminals 300 may select one input area from among at least two input areas displayed on an interface screen provided from the management server 500 to which the terminal 300 is connected via the communication network 400, and may send identified reaction is information of the input area to the management server 500 through the communication network 400.

The communication network 400 may be a network that assists in providing communication between the management server 500 and the plurality of terminals 300 as shown in FIG. 4. It should be understood that base communication technology for the communication network 400 does not affect specific implementation of the present invention.

Further, the communication network 400 may be realized in various manners, such as wired or wireless communication. The communication network 400 may be realized based on any type of communication technique enabling information exchange between a certain system and a terminal. Accordingly, various techniques known in the art may be applied to the communication network 400 to increase reliability and security in information exchange.

The management server 500 may adjust attributes of input areas based on the reaction information of the input areas previously selected by a user and/or other users on a user input standby screen.

The management server 500 may receive and cumulatively store reaction information of a certain input area selected from among two input areas displayed on a screen provided by a certain terminal 300 connected thereto through the communication network 400, extract reaction information of two input areas to be displayed on the screen in response to a subsequent inquiry, and adjust the attributes of the two input areas based on the respective numbers of selections of the extracted reaction information.

Next, the internal configuration and process of components of the management server 500 will be described.

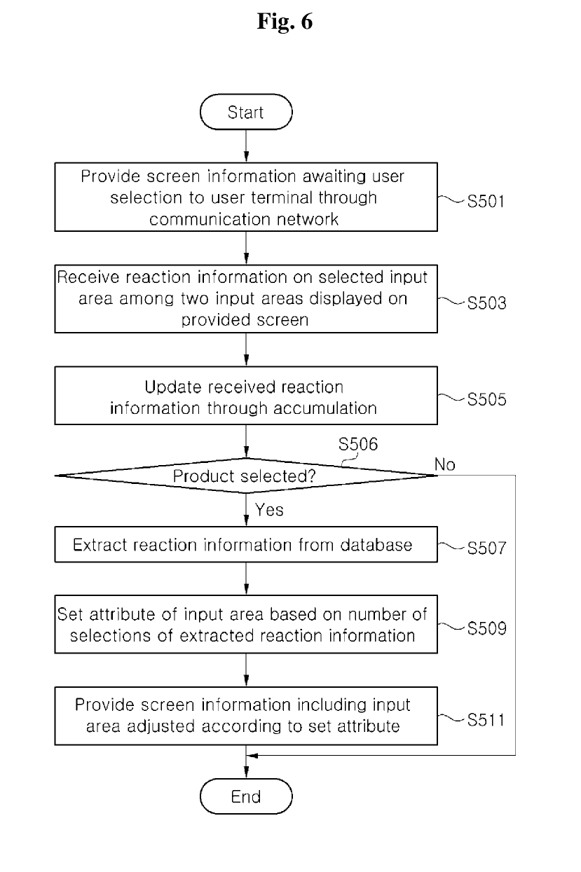

FIG. 5 is a block diagram of a management server according to an exemplary is embodiment of the present disclosure.

Referring to FIG. 5, the management server 500 according to the embodiment may include a user reaction information acquisition unit 501, a reaction information update unit 502, an input area exposure attributes adjustment unit 503, and an input area provision unit 504.

According to this embodiment, at least some of the user reaction information acquisition unit 501, the reaction information update unit 502, the input area exposure attributes adjustment unit 503 and the input area provision unit 504 may be program modules communicating with the plurality of terminals 300.

The program modules may be included in the management server 500 in the form of an operating system (OS), application program modules and other types of program modules, and may be recorded in a plurality of well-known memories. Moreover, the program modules may be recorded in remote controllable memories capable of communicating with the management server 500.

The program modules may include routine, subroutine, program, object, component, data structure and the like, capable of executing specific abstract data patterns or specific tasks which will be explained in this specification, without being limited thereto.

First, the input area provision unit 504 provides screen information, that is, an interface screen, awaiting a user selection through the communication network 400. Here, at least two input areas are displayed on the interface screen.

The user reaction information acquisition unit 501 receives, via the communication network 400, user reaction information on one input area, which is selected from among the two input areas displayed on the interface screen provided by the input area provision unit 504. Here, a first terminal 310 may identify the input area selected from the two input areas is displayed on the interface screen and temporarily store first reaction information on the identified input area. The first reaction information may include at least one among color information, product specification information, size information, and input area identification information which expresses from which web site the selected input area is provided and from which interface screen the selected input area is selected among interface screens provided by the web site. A second terminal 320 may temporarily store second reaction information on an input area.

The first and second reaction information may be user reaction information with respect to an input area selected from the same type of input areas provided corresponding to the same type of event.

The reaction information update unit 502 updates the first and second reaction information acquired by the user reaction information acquisition unit 501 such that the updated first and second reaction information are accumulated in the database 505. The database 505 may store reaction information received corresponding to identification information, based on which interface screens provided to the first and second terminals 310, 310 may be identified.

Further, the database 505 may store product information, sales information, shipment information, and inventory information.

The input area exposure attributes adjustment unit 503 adjusts attributes of two input areas in response to a subsequent inquiry in consideration of the numbers of selections in the updated reaction information stored in the database 505.

More specifically, the input area exposure attributes adjustment unit 503 extracts reaction information on the same type of input area with reference to the database 505, and adjusts attributes of input areas in a fixed ratio or in a corresponding ratio based on the number is of selections of the extracted reaction information.

For example, when two input areas are displayed on an interface screen, the input area exposure attributes adjustment unit 503 may determine an input area having a larger number of selections and an input area having a smaller number of selections by comparing the numbers of selections in the reaction information on the two input areas, and may adjust attributes of the two input areas such that the input area having a larger number of selections has a larger area than the input area having a smaller number of selections.

Further, for example, the input area exposure attributes adjustment unit 503 may determine an input area having the largest number of selections by comparing the number of selections of reaction information on 10 input areas with reference to the database 505, and adjusts the attributes of the input areas such that the color of the input area having the largest number of selections can be distinguished from those of the other 9 input areas.

Therefore, the management server according to this embodiment may determine which input areas are selected by a plurality of users. In other words, when products are purchased by users on the Internet, the management server according an exemplary embodiment may be capable of confirming preference of the users as to colors or specifications.

Further, in order to facilitate a user selection of products in an inventory, the input area exposure attributes adjustment unit 503 may determine, with reference to the database 505, whether a product selected by a user is in the inventory, and may adjust attributes of input areas such that an input area of a product in the inventory has a larger area than an input area of a product not in the inventory. On the contrary, the input area exposure attributes adjustment unit 503 may adjust the attributes of the input areas such that the input area of the product in the inventory has a smaller area than the input area of the product not in the inventory in order to is balance sales.

Although the present embodiment is illustrated as adjusting the areas of the input areas to be distinguished from each other, the present invention is not limited thereto. For example, the attributes of input areas may be adjusted by selecting at least one from among positions of the input areas, colors of the input areas, and text thickness and font inside the input areas.

The input area provision unit 501 may provide an interface screen having the two input areas, attributes of which are adjusted by the input area exposure attributes adjustment unit 503, to each of the first and second terminals 310, 320 through the communication network 400. An input area having a larger number of selections and an input area having a smaller number of selections among the at least two input areas are distinguishably displayed on the interface screen displayed on the first terminal 310 and second terminal 320.

Further, the input area provision unit 501 may send an interface screen, on which an operation of a certain input area selected from among input areas having different attributes is executed, to each of the first terminal 310 and second terminal 320 through the communication network 400. With such an execution, the management server 500 may cumulatively update reaction information on an input area selected by a user into recent reaction information in the database 505.

A communication unit (not shown) may send the input areas, attributes of which are adjusted by the management server 500, to the first terminal 310 and second terminal 320, and may recognize one input area selected from among the input areas displayed on the interface screen from each of the first terminal 310 and second terminal 320 to receive recognized reaction information. Generally, the communication unit enables data communication between the is respective components together with the management server 500.

The management server 500 may controls data flow among the user reaction information acquisition unit 501, the reaction information update unit 502, the input area exposure attributes adjustment unit 503, the input area provision unit 504, and the database 505. Specifically, the management server 500 may control data flow between the respective components to allow the user reaction information acquisition unit 501, the reaction information update unit 502, the input area exposure attributes adjustment unit 503, the input area provision unit 504 and the database 505.

Next, a method of adjusting attributes of input areas by the management server 500 upon selection by a plurality of users will be described.

FIG. 6 is a flowchart of a method of adjusting attributes of input areas based on user selections from first and second user terminals connected to a communication network according to one embodiment of the present disclosure.

The management server 500 may be a server operated to provide products or services. Here, the management server 500 will be illustrated as a management server capable of operating a web page for product purchase.

Referring to FIG. 6, the input area provision unit 504 provides an interface screen awaiting a user selection to each of the first and second terminals 310, 320 through the communication network 400 in S501. The interface screen displays user input areas, which may allow a user to select, for example, product colors.

Next, the user reaction information acquisition unit 501 receives a selection of one input area, which is selected from among user input areas displayed on the provided interface screens, from the first terminal 310 and second terminal 320, and receives first and is second reaction information on the selected input area in S503. The first terminal 310 and second terminal 320 may recognize and identify one input area selected from among at least two input areas displayed on the interface screen, and send the reaction information on the identified input area to the management server 500 through the communication network 400. Here, the reaction information may be temporarily stored in a storage unit of each terminal.

Then, the reaction information update unit 502 updates the first and second reaction information acquired by the user reaction information acquisition unit 501 to be accumulated in the database 505 in S505. The database 505 may be realized to store received reaction information corresponding to identification information which identifies the interface screen to which the input areas awaiting a user selection is provided.

Then, the input area exposure attributes adjustment unit 503 determines whether, for example, products are selected by the first terminal 310 and second terminal 320 communicating with the management server 500 through the communication network 400, in S506.

Upon determining in S506 that the products are not selected by the first terminal 310 and second terminal 320, the input area exposure attributes adjustment unit 503 enters a standby state for a predetermined period of time and finishes the process upon log-off of a user or disconnection with the management server 500.

Upon determining in S506 that the products are selected by the first terminal 310 and second terminal 320, the input area exposure attributes adjustment unit 503 extracts reaction information on the same type of input area from the database 505 in order to make the input areas distinguishable inside the interface screen allowing selection of product colors in S507.

The input area exposure attributes adjustment unit 503 adjusts attributes of the is input areas based on the number of selections of the reaction information in S509. Specifically, the input area exposure attributes adjustment unit 503 determines an input area having a larger number of selections and an input area having a smaller number of selections based on the numbers of selections of the extracted reaction information and adjusts area exposure attributes of the two input areas such that the input area having a larger number of selections is more emphasized than the input area having a smaller number of selections.

In particular, the input area exposure attributes adjustment unit 503 may adjust the areas of the input areas in proportion to the numbers of selections of the respective input areas. Additionally or independently, the input area exposure attributes adjustment unit 503 may adjust at least one of a color, position, thickness, size and font of text within each of the input areas. For example, in order to allow a user to distinguish the input areas, the input area exposure attributes adjustment unit 503 may adjust the attributes of the input areas such that the input area having a larger number of selections has a predetermined color and the input area having a smaller number of selections does not have a color.

Further, the input area exposure attributes adjustment unit 503 may adjust the attributes of the input areas by adjusting at least one of a thickness, size and font of text inside the input area having a larger number of selections without changing the attributes of the input area having a smaller number of selections from the default. Here, when the attributes of the input areas are adjusted in terms of area, the input area exposure attributes adjustment unit 503 may adjust the attributes of the input areas such that the input area having a smaller number of selections decreases in area depending on the area of the input area having a larger number of selections.

Next, the input area provision unit 504 provides an interface screen including the is input areas, attributes of which are adjusted by the input area exposure attributes adjustment unit 503, to each of the first terminal 310 and second terminal 320 through the communication network 400 in S511.

In this way, the management server 500 may be able to ascertain which input areas are selected by a user and other users by providing an interface screen including input areas, attributes of which are adjusted, to a plurality of terminals 300 communicating with the management server 500 through the communication network 400.

Particularly, when the attributes of the input areas are adjusted in terms of area, the attributes of the input areas are adjusted such that an input area having a larger number of selections has a larger area than an input area having a smaller number of selections when displayed on an UI screen, thereby facilitating not only a user selection of an input area which has been frequently selected in the past, but also determination as to reaction of other individuals, inventory, preference, and the like.

The embodiments of the present disclosure may be realized in the form of program instructions which can be implemented through various computer components, and may be recorded in a computer-readable storage medium. The computer-readable storage medium may include program instructions, a data file, a data structure, and the like either alone or in combination thereof. The program instructions recorded in the computer-readable storage medium may be any program instructions particularly designed and structured for the present disclosure or known to those skilled in the field of computer software. Examples of the computer-readable storage medium include magnetic recording media such as hard disks, floppy disks and magnetic tapes, optical data storage media such as CD-ROMs or DVD-ROMs, magneto-optical media such as floppy disks, and hardware devices, such as read-only memories (ROM), random-access memories (RAM), and flash memories, which are particularly structured to store and implement the program instruction. The computer-readable storage medium may be a transmission medium, such as light, wires, waveguides, and the like, which includes carrier waves transmitting signals designating program instructions, local data structure, and the like.

Examples of the program instruction include not only assembly language code formatted by a compiler but also a high level language code which can be implemented by a computer using an interpreter.

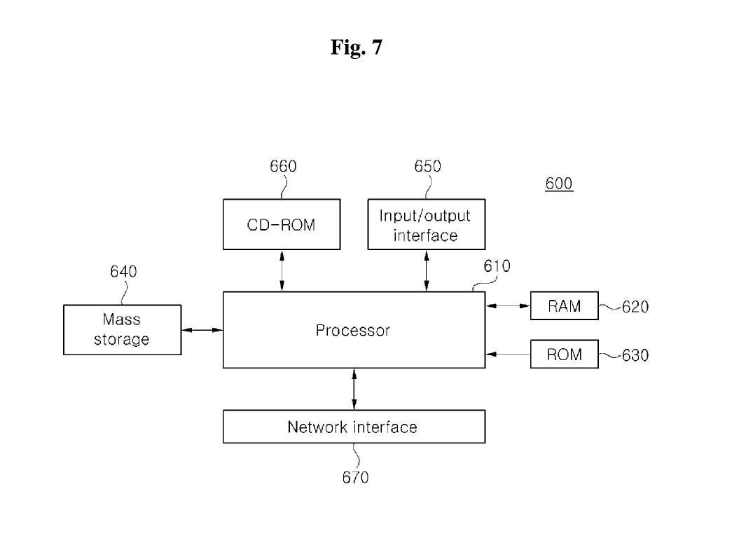

FIG. 7 is a block diagram of a computer that can be employed to execute a method of adjusting attributes of an input area based on user selections according to one exemplary embodiment of the present disclosure

A computer 600 includes at least a processor 610 connected to a primary storage including Random Access Memory (RAM) 620 and Read-Only Memory (ROM) 630. The processor 610 may be referred to as a central processing unit (CPU). As well known in the art, the ROM 630 allows unidirectional transmission of local data and instructions to the CPU, and the RAM 620 allows bidirectional transmission of local data and instructions. The RAM 620 and the ROM 630 may be realized in any suitable form of the computer readable medium. A mass storage 640 is bi-directionally connected to the processor 610 to provide additional local data storage capacity and may be realized by any computer-readable storage medium as described above. The mass storage 640 is used to store programs, local data, and the like, and is a secondary storage such as a hard disk, which is typically slower than the primary storage. A specific mass storage such as a CD-ROM 660 may also be used. The processor 610 is connected to at least one I/O interface, such as a video monitor, trackball, mouse, keyboard, microphone, touch screen type display, card recorder, magnetic or paper tape recorder, sound or writing recognizer, joystick, and other computer I/O devices known in the art. Furthermore, the processor 610 may be connected to a wired or wireless communication network through a network interface 670. The procedures of the method described above may be carried out through such network connection. The apparatus and instruments described above are well known to a person in the field of computer hardware and software technology.

The hardware devices may be configured to be operated by one or more software modules or vice versa to perform the processes according to the present disclosure.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A terminal providing a user input area, comprising:
a user reaction information acquisition unit to acquire reaction information based on at least one past user selection of an input area provided to a user;
a reaction information update unit to update the reaction information on the provided input area;
an input area exposure attributes adjustment unit to adjust attributes of the input area based on the updated reaction information; and
an input area provision unit to display an input area based on the adjusted attributes on a display unit in response to a user's request to provide an input area.

2. The terminal of claim 1, wherein the reaction information comprises at least one of input area identification information, from which, a screen that provides an input area is selected among screens provided by an application, and information on a number of the past user selections indicating how many times the provided input area has been selected by the user.

3. The terminal of claim 2, wherein the attributes comprise at least one attribute selected from: an area exposure attribute relating to an area of an input area, a color exposure attribute relating to a color of an input area, a position exposure attribute relating to a position of an input area, and a font exposure attribute relating to at least one of a thickness, font, color and size of text in an input area.

4. The terminal of claim 3, wherein, the reaction information comprises the information on the number of past user selections, and the input area exposure attributes adjustment unit extracts the number of past user selections from the updated reaction information and adjusts an area exposure attribute of the provided input area to be proportional to the extracted number of user selections.

5. The terminal of claim 3, wherein, the reaction information comprises the information on the number of past user selections, and the input area exposure attributes adjustment unit extracts second reaction information of a second user as the updated reaction information and adjusts the attributes of the input area based on a number of past user selections in the extracted reaction information of the second user.

6. A method of providing a user input area, comprising: by a terminal,
acquiring reaction information based on past user selections of an input area provided to a user;
updating the reaction information on the provided input area;
adjusting attributes of the input area based on the updated reaction information; and
displaying an input area based on the adjusted attributes on a display unit in response to the user's request to provide an input area.

7. The method of claim 6, wherein the reaction information comprises at least one of input area identification information, from which a screen providing an input area is selected among screens provided by an application, and information on a number of the past user selections indicating how many times the provided input area has been selected by the user.

8. The method of claim 7, wherein the attributes comprise at least one attribute selected from: an area exposure attribute relating to an area of an input area, a color exposure attribute relating to a color of an input area, a position exposure attribute relating to a position of an input area, and a font exposure attribute relating to at least one of a thickness, font, color and size of text in an input area.

9. The method of claim 8, wherein, the reaction information comprises the information on the number of the past user selections, and the adjusting attributes of the input area comprises extracting the number of the past user selections from the updated reaction information and adjusting an area exposure attribute of the provided input area to be proportional to the extracted number of the past user selections.

10. The method of claim 8, wherein, the reaction information comprises the information on the number of the past user selections, and the adjusting attributes of the input area comprises extracting second reaction information of a second user as the updated reaction information and adjusting the attributes of the input area based on a second number of past user selections in the second extracted reaction information of the second user.

11. A system to provide an attribute-adjustable input area to a user terminal based on user reaction information, comprising:
an acquisition unit to acquire reaction information based on a number of past user selections of an input area provided to a user terminal;
an update unit to update the reaction information on the provided input area;
an attribute adjustment unit to adjust at least one attribute of the input area based on the updated reaction information; and
an input area provision unit to display an input area based on the at least one adjusted attribute to be displayed on a display unit in response to a request to provide an input area from the user terminal.

12. A system to provide attribute-adjustable input areas to user terminals based on user reaction information, comprising:
an acquisition unit to acquire reaction information based on a number of user selections of an input area provided to a first user terminal;
an update unit to cumulatively update the reaction information on the input area based on the reaction information acquired from the first user terminal;
an attribute adjustment unit to adjust at least one attribute of the input area based on the updated reaction information on the input area; and
an input area provision unit to provide an input area based on the adjusted attribute to a second user terminal in response to a request to provide an input area from the second user terminal.

13. The system of claim 11, wherein the reaction information comprises at least one of: information on the number of past user selections indicating how many times the provided input area has been selected by the user, input area identification information as to from which web site the input area is provided and from which interface screen the input area is provided among interface screens provided by the web site, color information, product specification information, and size information.

14. The system of claim 13, wherein the at least one attribute is one of: an area exposure attribute relating to an area of an input area, a position exposure attribute relating to a position of an input area, a color exposure attribute relating to a color of an input area, and a font exposure attribute relating to at least one of a thickness, font, color and size of text in an input area.

15. The system of claim 14, wherein the reaction information comprises the number of past user selections, and the attribute adjustment unit extracts the number of past user selections from the updated reaction information and adjusts an area exposure attribute of the input area to be proportional to the extracted number of past user selections.

16. A method for providing an attribute-adjustable input area to a user terminal based on user reaction information, comprising: by a management server,
acquiring reaction information based on a number of user selections of an input area provided to a user terminal;
cumulatively updating the reaction information on the provided input area;
adjusting attributes of the input area based on the updated reaction information; and
providing an input area based on the adjusted attributes to the user terminal in response to a request to provide an input area from the user terminal.

17. A method for providing attribute-adjustable input areas to user terminals based on user reaction information, comprising:
acquiring reaction information based on a number of user selections of an input area provided to a first user terminal;
cumulatively updating the reaction information on the input area based on the reaction information acquired from the first user terminal;
adjusting attributes of the input area based on the updated reaction information on the input area; and
providing an input area based on the adjusted attributes to a second user terminal in response to a request to provide an input area from the second user terminal.

18. The method of claim 16, wherein the reaction information comprises at least one of: information on the number of user selections indicating how many times the provided input area has been selected by the user terminal, input area identification information as to from which web site the input area is provided and from which interface screen the input area is provided among interface screens provided by the web site, color information, product specification information, and size information.

19. The method of claim 18, wherein the attributes comprise at least one of: an area exposure attribute relating to an area of an input area, a position exposure attribute relating to a position of an input area, a color exposure attribute relating to a color of an input area, and a font exposure attribute relating to at least one of a thickness, font, color and size of text in an input area.

20. The method of claim 19, wherein, the reaction information comprises the information on the number of user selections, and the adjusting attributes of the input area comprises extracting the number of user selections from the updated reaction information and adjusting the area exposure attribute of the input area to be proportional to the extracted number of user selections.

21. A non-transitory computer-readable storage medium comprising an executable program, which when executed, performs the step of:
acquiring reaction information based on a number of user selections of an input area provided to a user;
cumulatively updating the reaction information on the provided input area;
adjusting attributes of the input area based on the updated reaction information; and
allowing an input area based on the adjusted attributes to be displayed on a display unit in response to the user's request to provide an input area.

22. A non-transitory computer-readable storage medium comprising an executable program, which when executed, performs the step of:
acquiring reaction information based on a number of user selections of an input area provided to a user terminal;
cumulatively updating the reaction information on the provided input area;
adjusting attributes of the input area based on the updated reaction information; and
providing an input area based on the adjusted attributes to the user terminal in response to a request to provide an input area from the user terminal.

23. A non-transitory computer-readable storage medium comprising an executable program, which when executed, performs the step of:
acquiring reaction information based on a number of user selections of an input area provided to a first user terminal;
cumulatively updating the reaction information on the input area based on the reaction information acquired from the first user terminal;
adjusting attributes of the input area based on the updated reaction information on the input area; and
providing an input area based on the adjusted attributes to a second user terminal in response to a request to provide an input area from the second user terminal.
